(19) United States
(12) Patent Application Publication
(10) Pub. No.: US 2014/0095902 A1
(43) Pub. Date: Apr. 3, 2014

(54) Power Saving Traffic Management Policies

(71) Applicants: Joseph Rorai, Kanata (CA); Kin-Yee Wong, Ottawa (CA)

(72) Inventors: Joseph Rorai, Kanata (CA); Kin-Yee Wong, Ottawa (CA)

(73) Assignee: ALCATEL-LUCENT CANADA INC., Kanata (CA)

(21) Appl. No.: 13/630,252

(22) Filed: Sep. 28, 2012

(51) Int. Cl. G06F 1/32

(52) U.S. Cl. 713/320

(57) ABSTRACT

A method and system are provided for reducing power usage in a telecommunications network. Policies are applied during traffic management of packets, the policies taking into account the power cost of transmitting a packet onward, including over a network. Embodiments are provided in which such policies are used during classification, scheduling, and traffic shaping of packets.

### FIELD OF INVENTION

This invention relates to traffic management policies, and more particularly to reduction of power consumption when operating telecommunications networks.

### BACKGROUND

Energy and power consumption are increasingly becoming a significant business issue as energy costs and environmental impact are becoming more important in business models. At the same time, the cost of providing energy may vary. The latter is becoming more common as utilities attempt to address finite energy generation by reducing demand for peak energy. The cost of energy may vary with time and/or geography. For example, there is often less demand for electricity late at night than in the middle of the day, and in an attempt to shift consumption of electricity to off-peak hours utilities may lower the cost of the electricity at night and raise the cost of the electricity during the day.

A method and system which allowed the power usage of a telecommunications network to be varied would provide the potential to realize environmental and monetary advantages by reducing power usage under certain conditions.

### SUMMARY

According to one aspect, an apparatus is provided, the apparatus including an interface and a data storage device storing computer program instructions. The apparatus also includes a processor communicatively coupled to the interface and to the data storage device. The processor, in cooperation with the data storage device, is configured to execute the computer program instructions, which when executed on the processor cause the processor to perform operations. The operations include receiving a packet, and applying a policy to the packet during traffic management, the policy taking into account the power cost of transmitting the packet onward.

According to another aspect, a method performed by ingress/egress data hardware is provided. A packet is received. A policy is then applied to the packet during traffic management, the policy taking into account the power cost of transmitting the packet onward.

According to another aspect, ingress/egress data hardware is provided. The ingress/egress data hardware comprises logic for receiving a packet, and for applying a policy to the packet during traffic management, the policy taking into account the power cost of transmitting the packet onward. The logic may be in the form of a general purpose processor, a network processor, a digital signal processor, an ASIC, or multiple such devices.

The methods of embodiments of the invention may be stored as logical instructions on a non-transitory computer-readable storage medium in a form executable by a computer processor.

Embodiments of the invention allow the power usage of a network to be reduced under certain conditions by implementing traffic management policies.

### BRIEF DESCRIPTION OF THE DRAWINGS

The features and advantages of embodiments of the invention will become more apparent from the following detailed description of the preferred embodiment(s) with reference to the attached figures, wherein:

FIG. 1 is a block diagram of traffic management hardware in a router;

FIG. 2 is a block diagram of a computing environment according to one embodiment of the invention;

FIG. 3 is a flowchart of a method carried out by the ingress and/or the egress data hardware of FIG. 1 according to one embodiment of the invention;

FIG. 4 is a flowchart of an example implementation of applying a policy based at least partially on the power cost of transmitting a packet according to one embodiment of the invention;

FIG. 5 is a flowchart of another example implementation of applying a policy based at least partially on the power cost of transmitting a packet according to one embodiment of the invention;

FIG. 6 is a flowchart of yet another example implementation of applying a policy based at least partially on the power cost of transmitting a packet according to one embodiment of the invention; and

FIG. 7 is a flowchart of yet another example implementation of applying a policy based at least partially on the power cost of transmitting a packet according to one embodiment of the invention.

It is noted that in the attached figures, like features bear similar labels.

### DETAILED DESCRIPTION OF THE PREFERRED EMBODIMENTS

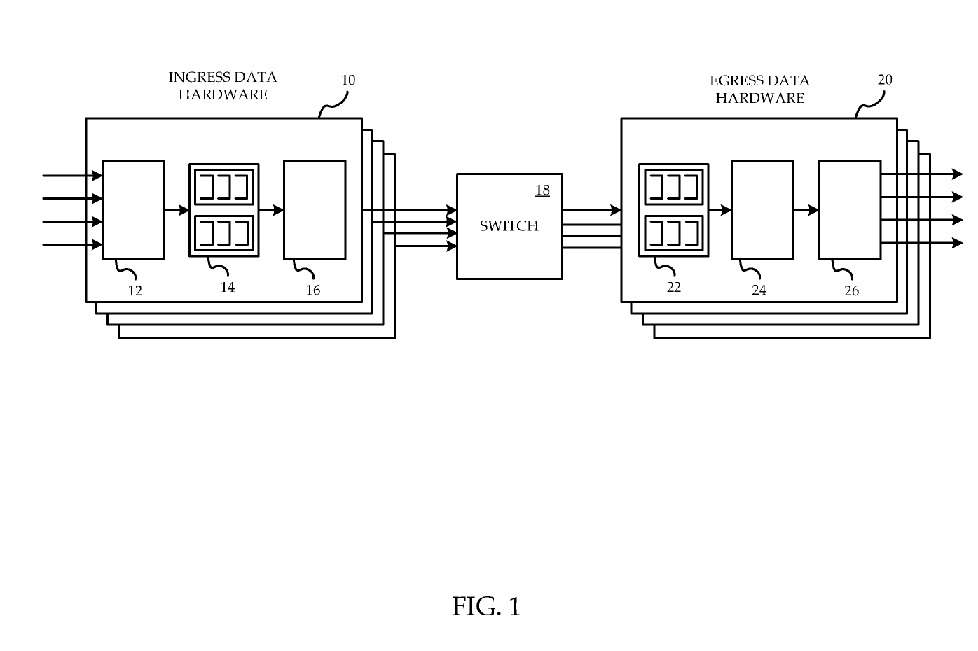

Referring to FIG. 1, a block diagram of traffic management hardware within a router is shown. Ingress data hardware 10 receives packets from a network (not shown), and the packets are passed to a classifier 12. The classifier 12 places each packet within one of multiple ingress queues 14, based for example on the priority of the packet. A scheduler/shaper 16 receives the packets, and after traffic shaping sends the packets to a switch 18. From the switch 18, the packets are sent to appropriate egress data hardware 20 based, inter alia, on the destination of the packet. Within the egress data hardware 20, the packets enter one of multiple egress queues 22, from which they are taken by a scheduler/shaper 24, and then delivered to output ports 26 for transmission to the network.

The traffic management hardware shown in FIG. 1 reflects a generic view of these functions in the ingress direction (data coming to the router/switch) and the egress direction (data leaving). In general, there can be multiple piece of hardware doing both ingress and egress, in single or multiple cards, with or without a switch connecting them. The entire hardware can be on a single card system. Each block can be different hardware components or integrated into single component. They can be general purpose processors, network processors, digital signal processors, or even ASICs. The queues are memories of some kind.

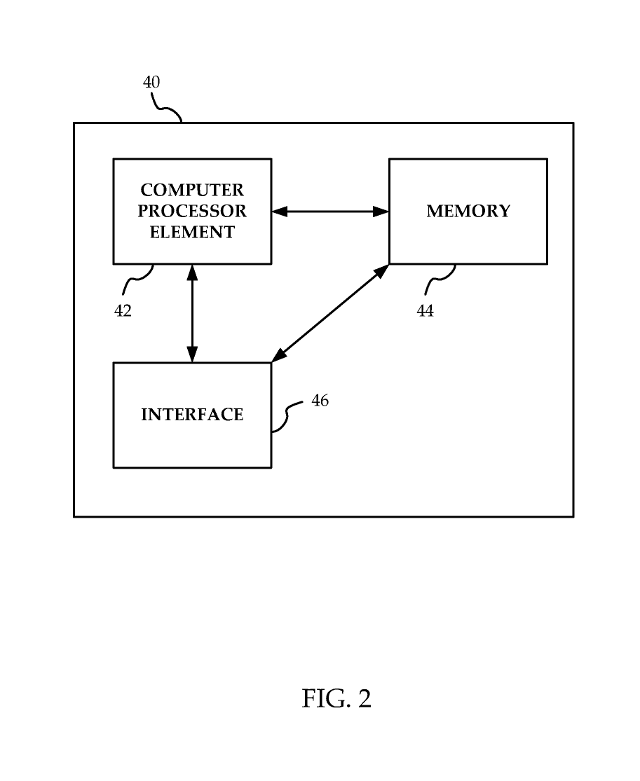

A simplified block diagram of one embodiment of classifier 12 is shown in FIG. 2 as a processor assembly 40. The processor assembly of FIG. 2 also shows an embodiment of the scheduler/shaper 16 of the ingress data hardware and the scheduler/shaper 24 of the egress data hardware. The processor assembly includes a computer processor element 42 (e.g. a central processing unit and/or other suitable processor(s)). The computer processor element 42 has access to a memory 44 (e.g. random access memory, read only memory, and the like). The processor element 42 and the memory 44 are also in communication with an interface comprising various I/O devices 46 (e.g. a user input device (such as a keyboard, a keypad, a mouse, and the like), an user output device (such as a display, a speaker, and the like), an input port, an output port, a receiver, a transmitter, and a storage device (such as a tape drive, a floppy drive, a hard disk, a compact disk drive, and the like)). In one embodiment, the classifier 12, the scheduler/shaper 16, and/or the scheduler/shaper 24 are implemented as software instructions loaded into the memory 44 and causing the computer processor element 42 to execute the methods described below.

Power efficiency is a measure of achievement of the lowest power consumption while still being able to provide all the services and bandwidth requested in the network. Determining whether it is power efficient to deliver a packet can mean determining whether all the services and bandwidth requested can be provided at the lowest cost if the packet is delivered. Power efficiency can be expressed in units of Watts per Gpbs, as an example unit. Power cost is the price paid by the network operator for power consumed by the network and supporting equipment. The power cost may be a fixed number or may be variable based on the time of day. Power cost can be expressed in units of $ per kWh, as an example unit.

Broadly, when a packet is received, a policy is applied to the packet during traffic management, the policy taking into account the power cost of transmitting the packet onward. This may be performed by a processor communicatively coupled to a data storage device storing instructions for causing the processor to execute such a method. As a more specific embodiment, this may be performed by ingress/egress data hardware comprising logic for executing such a method. Depending on the embodiment, the logic may be in the form of a classifier or of a scheduler/shaper, and in either case may be more particularly the form of a general purpose processor, a network processor, a digital signal processor, an ASIC, or multiple such devices.

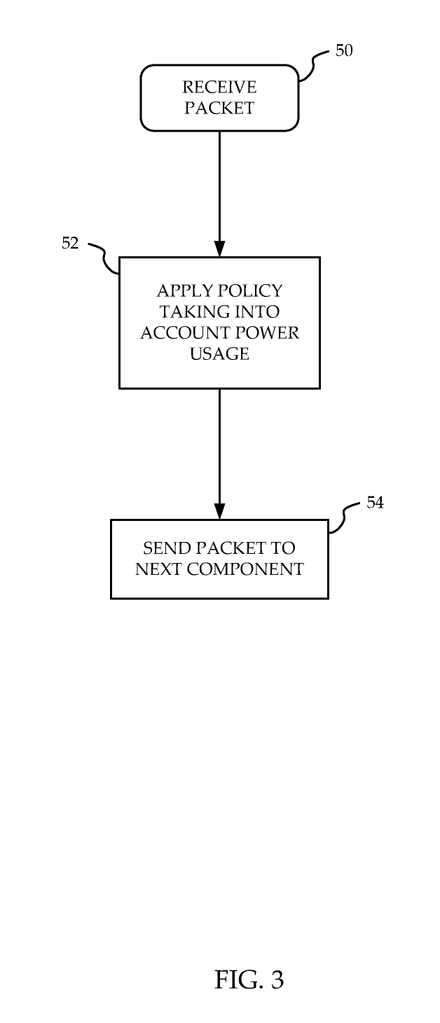

Referring to FIG. 3, a flowchart of a method carried out by the ingress data hardware and/or the egress data hardware (referred to hereinafter as the “ingress/egress data hardware”) according to one embodiment of the invention is shown. The method is triggered at step 50 when the appropriate component of the ingress/egress data hardware, such as the classifier 12, the scheduler/shaper 16, or the scheduler/shaper 24 receives a packet to be transmitted. At step 52 the ingress/egress data hardware applies a policy to the packet, the policy based at least partially on the power usage used in transmitting the packet from the ingress/egress data hardware and/or transmission through the network. At step 54 the component of the ingress/egress data hardware which applied the policy sends the packet onward, such as to the queue 14, the switch 18, or the output ports 26.

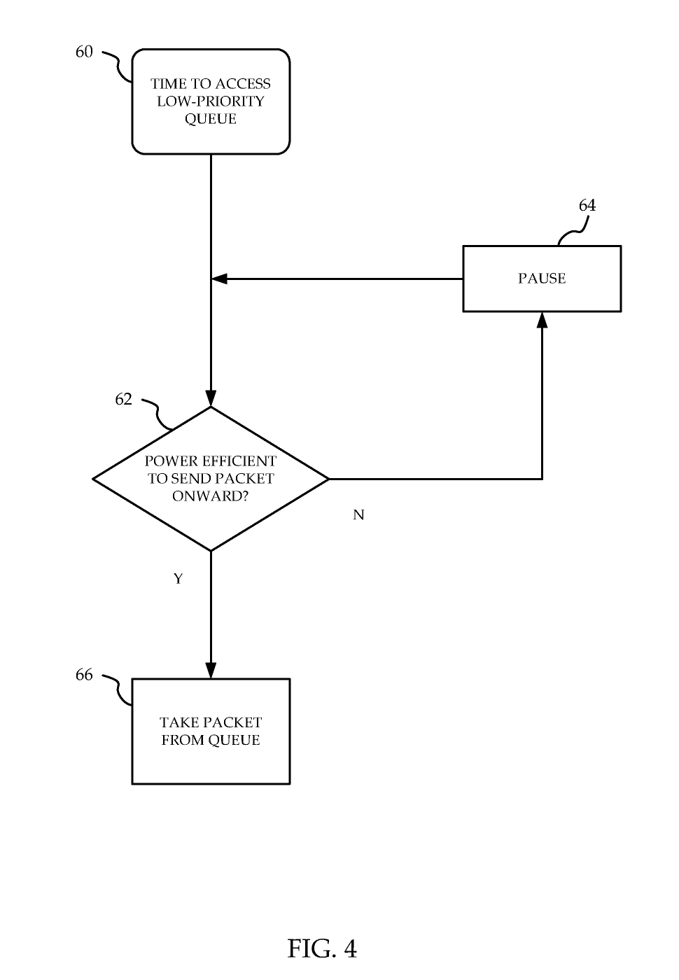

Referring to FIG. 4, a flowchart of an example implementation of the step 52 of applying a policy based at least partially on the power cost of transmitting the packet is shown according to one embodiment of the invention. In this embodiment, the policy is applied by either the scheduler/shaper 16 of the ingress data hardware 10 or the scheduler/shaper 24 of the egress data hardware 20. The implementation will be described with reference to the scheduler/shaper 16 of the ingress data hardware 10 for ease of explanation and understanding, but it is to be understood that this embodiment can also be implemented in the other scheduler/shaper 24. At step 60, for one of the queues 14 having a low-priority such as a queue for non-real time data packets, the scheduler/shaper 16 determines that is time to access the queue. The decision at step 60 to access the queue is based on usual traffic scheduling routines. At step 62 the scheduler/shaper 16 determines whether it is power-efficient to transmit a packet from the queue onward, including possibly the power cost of sending the packet over the network. For example, if the current cost of power is above a threshold, then the scheduler/shaper 16 decide not to transmit the packet since the packet has a low-priority and transmission can be delayed. As another example, if the network operating cost of sending the packet to its destination is above a threshold, then transmission of the packet is delayed. If the scheduler/shaper 16 determines at step 62 that it is not power-efficient to transmit the packet, then the scheduler/shaper 16 leaves the packet in the queue and pauses at step 64 (such as on the order of milliseconds), and then makes the power-efficiency determination again. Alternatively, the scheduler/shaper 16 returns to waiting for the next access time for the queue at step 60. If the scheduler/shaper 16 determines at step 62 that it is power-efficient to send a packet from a low-priority queue onward, then at step 66 the scheduler/shaper 16 retrieves a packet from the low-priority queue for the usual further processing.

As an alternative, if the scheduler/shaper 16 determines at step 62 that it is not power-efficient to send the packet to the network, then the scheduler/shaper 16 retrieves the packet and places it in a separate buffer until it is determined to be power-efficient to send the packet. One advantage of using a separate buffer is that more packets can usually be stored, albeit often at the expense of speed of processing packets and an increased hardware cost.

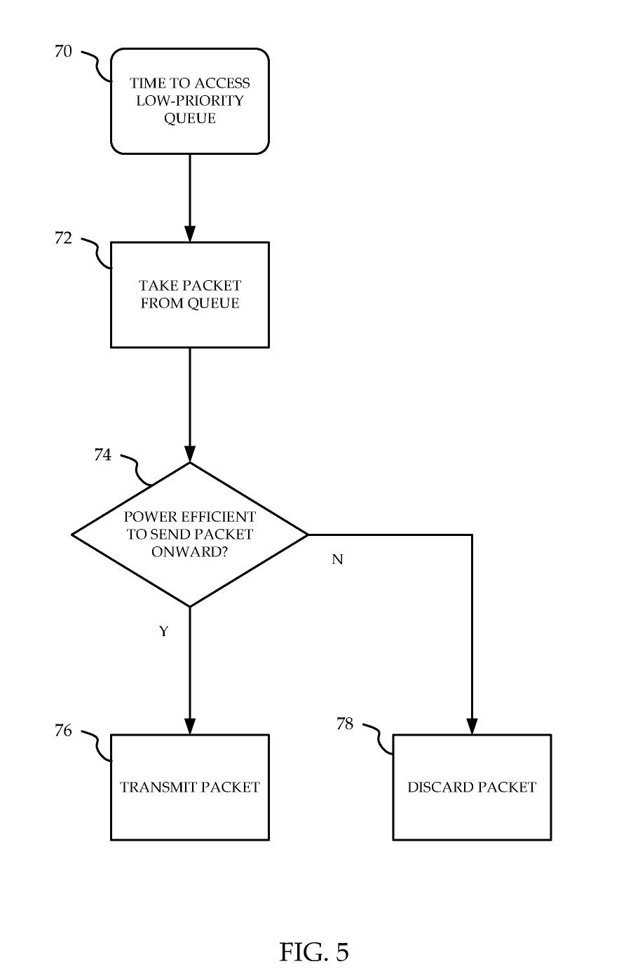

Referring to FIG. 5, a flowchart of another example implementation of the step 52 of applying a policy based at least partially on the power cost of transmitting the packet is shown according to one embodiment of the invention. In this embodiment, the policy is applied by either the scheduler/shaper 16 of the ingress data hardware 10 or the scheduler/shaper 24 of the egress data hardware 20. The implementation will be described with reference to the scheduler/shaper 16 of the ingress data hardware 10 for ease of explanation and understanding, but it is to be understood that this embodiment can also be implemented in the other scheduler/shaper 24. At step 70, for one of the queues 28 having a low-priority such as a queue for non-real time data packets, the scheduler/shaper 16 determines that is time to access the queue. The decision at step 70 to access the queue is based on usual traffic scheduling routines. At step 72 the scheduler/shaper 16 takes a packet from the low-priority queue. At step 74 the scheduler/shaper 16 determines whether it is power-efficient to transmit a packet from the queue onward. For example, the current cost of power may be above a threshold, or the current network operating one of sending the packet to its destination may be above a threshold. If the scheduler/shaper 16 determines at step 74 that it is power-efficient to transmit the packet, then the scheduler/shaper 16 performs further usual processing and at step 76 transmits the packet onward (equivalent to step 54 in FIG. 3). If the scheduler/shaper 16 determines at step 74 that it is not power-efficient to send the packet over the network, then at step 78 the packet is discarded.

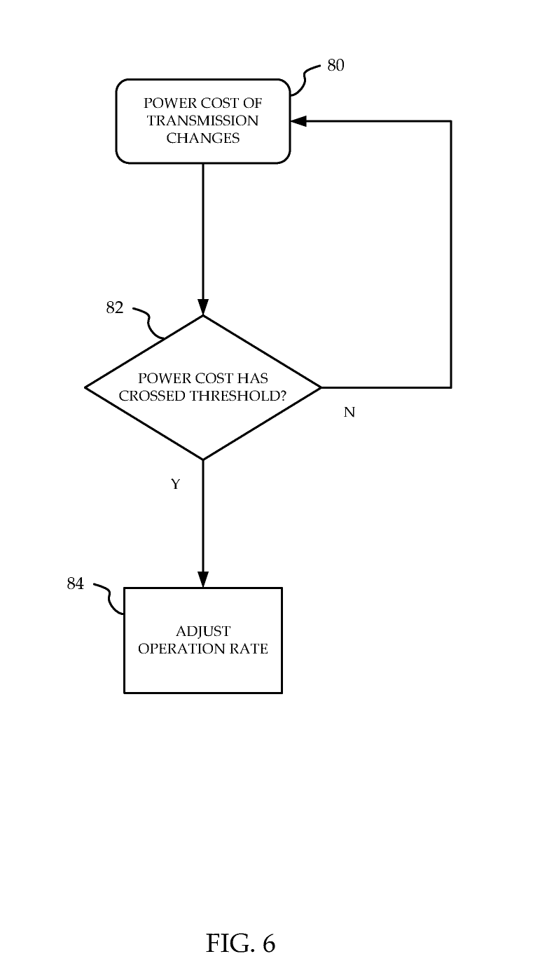

Referring to FIG. 6, a flowchart of another example implementation of the step 52 of applying a policy based at least partially on the power cost of transmitting the packet is shown according to one embodiment of the invention. In this embodiment, the policy is applied by either the scheduler/shaper 16 of the ingress data hardware 10 or the scheduler/shaper 24 of the egress data hardware 20. The implementation will be described with reference to the scheduler/shaper 16 of the ingress data hardware 10 for ease of explanation and understanding, but it is to be understood that this embodiment can also be implemented in the other scheduler/shaper 24. Broadly, in this implementation traffic scheduling is performed in such a way that the rate of operation of components involved in packet transmission is reduced when power usage dictates. The method is triggered at step 80 when the power cost of transmitting packets over the network changes. For example, the real-time cost of power may change based on the current time of day or day of the week. At step 82 the scheduler/shaper 16 determines whether the power cost of transmitting packets has crossed a threshold, either by crossing above a threshold or crossing below a threshold, the thresholds possibly having different values in order to avoid rapid switching of states. If the power cost has crossed a threshold, then the operation rate of various components is changed. For example, the rate at which the scheduler/shaper 16 accesses the queues 14 may be changed, i.e. traffic shaping is changed. The effect of this is to raise or lower the transmission rate, i.e. the link bandwidth of the link to which the output ports 26 lead.

A similar embodiment uses the amount of real time traffic rather than the power cost of traffic in determining whether to adjust the traffic shaping. Real time traffic often decreases at night and increases during the day. If the scheduler/shaper 16 determines that the amount of real time traffic has crossed a threshold, then the rate of operation of various components involved in the transmission of packets, such as the access times of the queues 14, may be raised or lowered in order to reduce power costs by reducing link bandwidth when possible or raising link bandwidth when necessary.

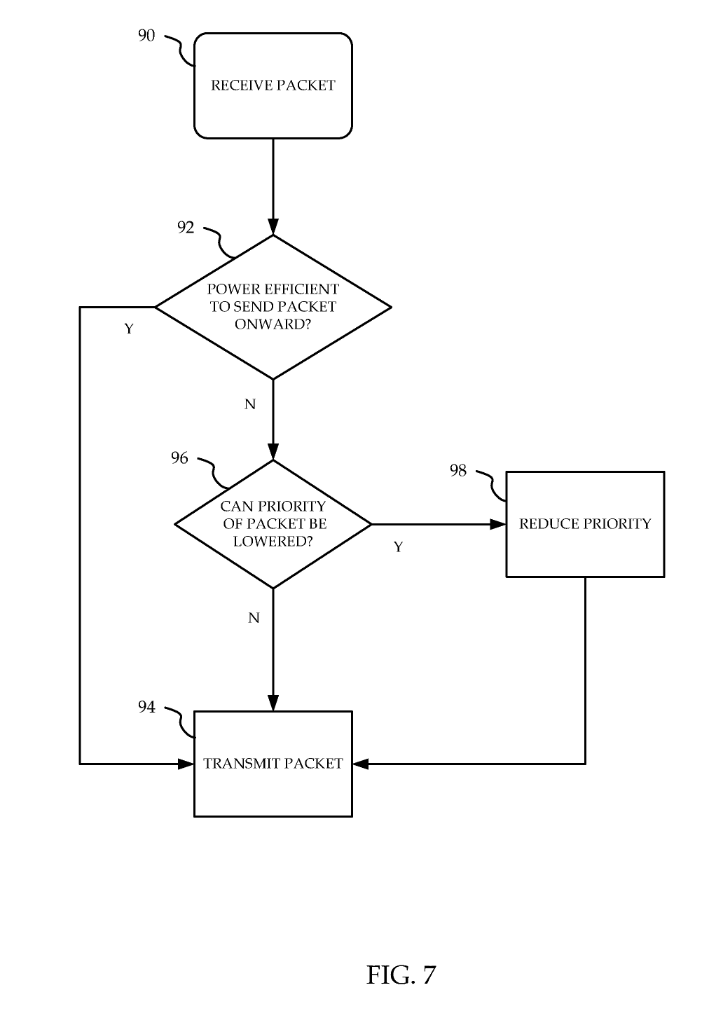

Referring to FIG. 7, a flowchart of another example implementation of the step 52 of applying a policy based at least partially on the power cost of transmitting the packet is shown according to one embodiment of the invention. In this embodiment, the policy is applied by classifier 12. The method is triggered at step 90 when the classifier 12 receives a packet. The packet has a priority, for example defined within the packet header in the case of an IPv4 packet, which is used to determine into which queue 14 the packet is normally placed by the classifier 12. Before placing the packet in one of the queues 14, however, the classifier 12 determines at step 92 whether it is power efficient to send the packet onward, including over the network to the destination of the packet. If the classifier 12 determines that it is power efficient to send the packet onward, then at step 94 the classifier 12 passes the packet on to other components as is by placing the packet in a queue 14 appropriate to the original priority of the packet.

If however the classifier 12 determines at step 92 that it is not power efficient to send the packet onward, then at step 96 the classifier 12 determines whether the priority of the packet can be reduced. For example, for real-time packets of video conferencing the priority of the packet can usually not be reduced. As another example, the originator of the packet may have paid extra for a QoS in which all packets originating from the originator have top priority. As a counterexample, the packet may represent an email data packet, and it is reasonable to reduce the priority of such a packet.

If the classifier 12 determines at step 96 that the priority of the packet cannot be reduced, then at step 94 the classifier 12 passes the packet on to other components as is by placing the packet in a queue 14 appropriate to the original priority of the packet. If however the classifier 12 determines at step 96 that the priority of the packet can be reduced, then at step 98 the classifier 12 reduces the priority of the packet. The classifier 12 then passes the packet on to other components by placing the packet in a queue 14 appropriate to the new priority of the packet.

In various embodiments, a component of the ingress/egress data hardware determines whether it is power efficient to send a packet onward. The ingress/egress data hardware knows the destination of the packet, and in some implementations even knows the path that the packet will use. The determination as to whether it is efficient to send the packet onward uses whatever information is available to the ingress/egress data hardware to determine or estimate the total cost of power of transmitting the packet to its destination, and if this total cost of power exceeds a configured threshold then the ingress/egress data hardware concludes that it is not power efficient to send the packet onward. Conversely, if this total cost of power does not exceed the configured threshold then the ingress/egress data hardware concludes that it is power efficient to send the packet onward. In making this comparison, the total cost of power and the threshold can be expressed in any of a number of ways, such as $, kWh, $/kWh, or even $/distance.

The methods described above are preferably implemented as logical instructions in the form of software. Alternatively, the logic of the methods described above may be implemented as hardware, or as a combination of software or hardware. If in the form of software, the logic may be stored on a non-transitory computer-readable storage medium in a form executable by a computer processor.

The embodiments presented are exemplary only and persons skilled in the art would appreciate that variations to the embodiments described above may be made without departing from the spirit of the invention. The scope of the invention is solely defined by the appended claims.

I/We claim:

1. An apparatus comprising:
an interface;
a data storage device storing computer program instructions; and
a processor communicatively coupled to the interface and to the data storage device, the processor, in cooperation with the data storage device, configured to execute the computer program instructions, which when executed on the processor cause the processor to perform operations comprising:
receiving a packet;
applying a policy to the packet during traffic management, the policy taking into account the power cost of transmitting the packet onward.

2. The apparatus of claim 1, wherein applying a policy comprises:
determining whether it is power efficient to send a packet in a low priority queue onward;
if it is determined that it is power efficient to send the packet onward, retrieving the packet and sending it onward; and
if it is determined that it is not power efficient to send the packet onward, leaving the packet in the low priority queue.

3. The apparatus of claim 1 wherein applying a policy comprises:
retrieving a packet from a low priority queue;
determining whether it is power efficient to send the packet in a low priority queue onward;
if it is determined that it is power efficient to send the packet onward, sending the packet onward; and
if it is determined that it is not power efficient to send the packet onward, discarding the packet.

4. The apparatus of claim 1 wherein applying a policy comprises:
performing traffic scheduling such that the rate of operation of components involved in packet transmission is reduced.

5. The apparatus of claim 1 wherein applying a policy comprises:
determining whether it is power efficient to send the packet in a low priority queue onward;
if it is determined that it is not power efficient to send the packet onward, determining whether the priority of the packet can be reduced; and
if it is determined that the priority of the packet can be reduced, reducing the priority of the packet.

6. A method performed by ingress/egress data hardware, comprising:
receiving a packet;
applying a policy to the packet during traffic management, the policy taking into account the power cost of transmitting the packet onward.

7. The method of claim 6, wherein applying a policy comprises:
determining by a scheduler/shaper whether it is power efficient to send a packet in a low priority queue onward;
if it is determined that it is power efficient to send the packet onward, retrieving by the scheduler/shaper the packet and sending it onward; and
if it is determined that it is not power efficient to send the packet onward, leaving the packet in the low priority queue.

8. The method of claim 6 wherein applying a policy comprises:
retrieving by a scheduler/shaper a packet from a low priority queue;
determining whether it is power efficient to send the packet in a low priority queue onward;
if it is determined that it is power efficient to send the packet onward, sending the packet onward; and
if it is determined that it is not power efficient to send the packet onward, discarding the packet.

9. The method of claim 6 wherein applying a policy comprises:
a scheduler/shaper performing traffic scheduling such that the rate of operation of components within the ingress/egress data hardware involved in packet transmission is reduced.

10. The method of claim 6 wherein applying a policy comprises:
determining whether it is power efficient to send the packet in a low priority queue onward;
if it is determined that it is not power efficient to send the packet onward, determining whether the priority of the packet can be reduced; and
if it is determined that the priority of the packet can be reduced, a classifier reducing the priority of the packet.

11. Ingress/egress data hardware comprising logic for:
receiving a packet;
applying a policy to the packet during traffic management, the policy taking into account the power cost of transmitting the packet onward.

12. The ingress/egress data hardware of claim 11, wherein the logic is in the form of a scheduler/shaper, and wherein the logic for applying a policy comprises logic for:
determining whether it is power efficient to send a packet in a low priority queue onward;
if it is determined that it is power efficient to send the packet onward, retrieving the packet and sending it onward; and
if it is determined that it is not power efficient to send the packet onward, leaving the packet in the low priority queue.

13. The ingress/egress data hardware of claim 12 wherein the logic in the form of a general purpose processor, a network processor, a digital signal processor, an ASIC, or multiple such devices.

14. The ingress/egress data hardware of claim 11, wherein the logic is in the form of a scheduler/shaper, and wherein the logic for applying a policy comprises logic for:
retrieving a packet from a low priority queue;
determining whether it is power efficient to send the packet in a low priority queue onward;
if it is determined that it is power efficient to send the packet onward, sending the packet onward; and
if it is determined that it is not power efficient to send the packet onward, discarding the packet.

15. The ingress/egress data hardware of claim 14 wherein the logic in the form of a general purpose processor, a network processor, a digital signal processor, an ASIC, or multiple such devices.

16. The ingress/egress data hardware of claim 11, wherein the logic is in the form of a scheduler/shaper, and wherein the logic for applying a policy comprises logic for performing traffic scheduling such that the rate of operation of components within the ingress/egress data hardware involved in packet transmission is reduced.

17. The ingress/egress data hardware of claim 16 wherein the logic in the form of a general purpose processor, a network processor, a digital signal processor, an ASIC, or multiple such devices.

18. The ingress/egress data hardware of claim 11, wherein the logic is in the form of a classifier, and wherein the logic for applying a policy comprises logic for:
determining whether it is power efficient to send the packet in a low priority queue onward;
if it is determined that it is not power efficient to send the packet onward, determining whether the priority of the packet can be reduced; and
if it is determined that the priority of the packet can be reduced, reducing the priority of the packet.

19. The ingress/egress data hardware of claim 16 wherein the logic in the form of a general purpose processor, a network processor, a digital signal processor, an ASIC, or multiple such devices.
